(19) United States
(12) Patent Application Publication
(10) Pub. No.: US 2012/0278857 A1
(43) Pub. Date: Nov. 1, 2012

(54) METHOD FOR UNLOCKING A SECURE DEVICE

(75) Inventors: Lionel Merrien, Montreal (CA); Rodrigo Ferreira Da Silva, Verdun (CA)

(73) Assignee: GEMALTO SA, Meudon (FR)

(21) Appl. No.: 13/519,975

(22) PCT Filed: Dec. 24, 2010
(86) PCT No.: PCT/CA10/02063

§ 371 Date: Jun. 29, 2012

(30) Foreign Application Priority Data
Dec. 30, 2009 (CA) PCT/CA2009/001901

(51) Int. Cl. G06F 21/00

(52) U.S. Cl. 726/3

(57) ABSTRACT

The present invention provides a method for unlocking a secure device (1), said secure device (10) being adapted to be associated with a first device (11) and being adapted to be locked when it is associated to a second device (12) different from the first device (11), said first device (11) being the paired device, the method comprising a step of unlocking the secure device (1) over-the-air when the secure device (1) is connected to the second device (12).

### FIELD OF THE INVENTION

The invention relates to the field of wireless telecommunications, and especially deals with a method for unlocking a secure device and subscription token.

### BACKGROUND OF THE INVENTION

A subscription secure token, such as a UICC can host an application that will associate the token to a particular host device, such as a wireless handset. This procedure is referred to as “IMEI Lock” application or “SIM Locking” application.

If the subscription secure token is inserted into a different host device, then the token does not provide the appropriate credentials to connect to the network. In order to recognize the device with which it is associated, the token uses a unique identifier of the host device, such as the IMEI. This identifier is retrieved by the subscription secure token from the host device during the power-up sequence, before attachment to the network. This association may be provided by inserting the secure token into the host device the first time. The secure token includes data that allows the handset to authenticate itself with the network and to receive services from the network.

The particular handset, also called paired handset, is uniquely identified in a network. In a telecommunication network for example under the GSM system, the paired handset is uniquely identified by identifiers such as the International Mobile Equipment Identification (“IMEI”) as defined in GSM 03.03—version 3.6.0.

The IMEI Lock application locks the UICC to the particular handset also called the paired handset with which it is associated to, by retrieving for example the IMEI of the current handset and checking if it matches with the IMEI of the paired handset. Then if a UICC is inserted in an unauthorised handset, i.e. in a handset different from the paired handset, the IMEI Lock application prevents the unauthorised handset from attaching to the network through various methods, for example by running an infinite loop, replacing the IMSI file, etc . . . The unauthorised handset may for example display a message requesting that the user enters an unlocking code, or may simply display a message indicating that the secure device is locked.

Unfortunately, once the UICC is in a lock mode, there is no way to unlock it over-the-air (OTA), since it cannot be reached anymore on the network.

### SUMMARY OF THE INVENTION

It is an object of the invention to provide a method for unlocking a secure device over-the-air.

Thereto, the present invention provides a method for unlocking a secure device, said secure device being adapted to be associated with a first device and being adapted to be locked when it is associated to a second device different from the first device, said first device being the paired device, the method comprising a step of unlocking the secure device over-the-air when the secure device is connected to the second device.

According to other aspects of the invention:
the method may comprise a step of sending a notification to an over-the-air server just after the detection of the second device and before locking the secure device;
the secure device may wait for a response from the over-the-air server, said response being sent as a response to the notification sent to the over-the-air server just after the detection of the second device, before being in a lock mode;
the secure device may wait for a response from the over-the-air server, said response being sent as a response to the notification sent to the over-the-air server just after the detection of the second device, before pairing the second device to the secure device;
the method may comprise taking into account a new pairing request only after the second device is rebooted;
it may comprise exchanging data between the over-the-air server and the secure device using IP or data channel;
it may comprise exchanging data between the over-the-air server and the secure device using SMS channel;
it may comprise using an UICC device as secure device;
it may comprise using handsets as first and second device;
it may comprise using the International Mobile Equipment Identification of respectively the first and the second device as identifiers.

Thanks to this method, it becomes easy to unlock a secure device without using any unlock password.

The invention is now described, by way of example, with reference to the accompanying drawings. The specific nature of the following description should not be construed as limiting in any way the broad nature of this summary.

### BRIEF DESCRIPTION OF THE DRAWINGS

In order that the manner in which the above recited and other advantages and features of the invention are obtained, a more particular description of the invention briefly described above will be rendered by reference.

Notwithstanding any other forms that may fall within the scope of the present invention, preferred forms of the invention will now be described, by way of example only, with reference to the accompanying drawing in which:

FIG. 1 schematically shows an embodiment of a method according to the invention in a nominal use case.

### DETAILED DESCRIPTION OF THE PREFERRED EMBODIMENTS

The present invention may be understood according to the detailed description provided herein.

The invention deals with a method for unlocking a secure device 10 over-the-air.

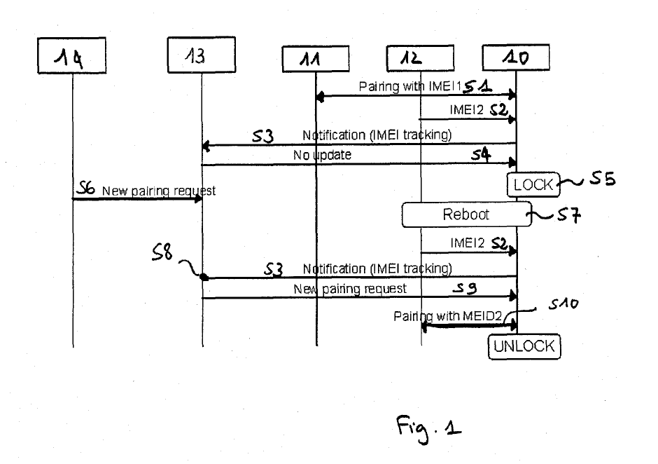

Shown in FIG. 1 is a secure device 10 such as a Universal Integrated Circuit Card (UICC) also called smart card or subscriber identification module (SIM) card, paired to a first handset 11 such as a mobile device—step S1. This first handset 11 is uniquely identified by a first identifier. In this embodiment the identifier is the International Mobile Equipment Identification of the paired handset 11. The first identifier will be called the first International Mobile Equipment Identification IMEI1.

A second handset 12 is uniquely identified by a second identifier also called second International Mobile Equipment Identification IMEI2.

When a user inserts the secure device 10 in the second handset 12 in step S2, a locking application also called IMEI Lock application or locking application hereinafter stored in the secure device 10, detects that the current handset 12 in not the paired handset 11, i.e. the first handset 11 as it should be.

This is for example made by the comparison of the second identifier IMEI2 of the second handset 12 in which the secure device 10 is inserted, with the expected paired identifier IMEI1. The locking application compares IMEI2 with the first identifier IMEI1.

Just after the locking application has detected that the current handset 12 is not the expected paired handset 11, and before going into a lock mode which prevents the handset 12 from attaching to the network, the locking application sends notification to an Over-the-air 3 in step S3.

The OTA server is the one responsible for authorizing the pairing request. The authorization response may include other updates in the UICC (files and/or applications). The notification, when performed by IP, will be HTTPS POST optionally including some data that can be used by the OTA Server to validate the pairing as for example, the new identifier, the previous identifier, the user identification, etc . . .

This notification gives the choice to the OTA server to send an update to the locking application, in order either to disable it, or to pair the secure device 10 with the second handset 12.

The notification is preferably sent by an IP/data channel.

This process, when performed via IP/data channel is faster than when using SMS channel and it does not have the limitations that a SMS channel has.

In step S4, the locking application then waits for the Over-The-Air server to close the data channel, so as to know for example that there is no pending update, or no pending request from the Over-The-Air server.

The communication is done by using HTTP over BIP protocol. There are a set of events that are used by the. UICC to know that a channel has been dropped (when for example the user looses coverage). In this case, the UICC will send a proactive command (CLOSE CHANNEL) to the device asking the close of the channel.

In other cases where no error occurs in the communication, the OTA server sends to the UICC an answer to the HTTP indicating to the UICC that there is no additional information to be sent. The UICC then sends a command “CLOSE CHANNEL” to the handset.

In any situation above, the application is notified when the communication is finished and at this moment it takes the decision based on the information received—if any—if it locks or not the UICC.

When the secure device 10 receives no update request or no response from the Over-The-Air server once the data channel has been closed, the locking application goes into a locking mode in step S5.

The locking application runs the same steps at each secure device initialization process, so as a customer care agent 14 in step S6 is able to send an unlock request to the OTA server.

According to the invention, only one handset is paired to the UICC. This means that once the UICC is paired with handset 12, if it is inserted in the handset 11 again, the lock mechanism will be triggered. A new pairing authorization request is sent to the OTA server. In case the handset 12 is not authorized by the OTA server, the UICC is still paired with handset 11, meaning that if inserted back into handset 11, it will properly function.

The unlock request will be taken into account when the user will reboot the new paired handset 12, which is here the second handset 12.

Then when the user switches on the second handset 12 in step S7, the locking application runs for example step S2. It then detects the second identifier IMEI2 of the second handset 12 and sends a notification to the Over-The-Air server as in step S3.

When receiving this notification, the Over-The-Air server checks whether it has received a new pairing request or not in step S8. As the Over-The-Air server 13 received a pairing request in step S6, the Over-The-Air server 13 sends in step S9, pairing request to the secure device 10. In step S10, the secure device 10 is paired with the new paired handset 12, which is the second handset 12.

As the secure device 10 is paired with the second handset 12, the second handset 12 may be attached to the network as the UICC has been unlocked over-the-air.

Thanks to this method, it becomes easy to unlock a secure device without using any unlock password.

Another advantage is that this method allows to unlock the secure device 10 Over-The-Air even if the initial paired handset 11 is not available.

The invention also gives the flexibility to an operator to implement the unlock automatically based on a specific rule, for example, if the IMEI belongs to an operator device database. The user does not need to call the customer service in some kinds of replacement.

1. A method for unlocking a secure device (10), said secure device (10) being adapted to be associated to a first device (11) and being adapted to be locked when it is associated to a second device (12) different from the first device (11), said first device being the paired device, the method comprising a step of unlocking the secure device (1) over-the-air when the secure device (10) is connected to the second device (12).

2. The method according to claim 1 further comprising sending a notification (S3) to an over-the-air server (13) just after the detection of the second device (12) and before locking the secure device (10).

3. The method according to claim 2, wherein the secure device (10) is waiting for a response from the over-the-air server (13), said response being sent as a response to the notification sent in step S3, before being in a lock mode.

4. The method according to claim 2, wherein the secure device (10) is waiting for a response from the over-the-air server (13), said response being sent as a response to the notification sent in step S3, before pairing the second device (12) to the secure device (10).

5. The method according to one of the previous claims, wherein it the method comprises taking into account a new pairing request (S6, S9) only after the second device (12) is rebooted.

6. The method according to one of claims 1 through 4, wherein the method comprises exchanging data between the over-the-air server (13) and the secure device (10) using IP or data channel.

7. The method according to one of claims 1 to 4, wherein the method comprises exchanging data between the over-the-air server (13) and the secure device (10) using SMS channel.

8. The method according to one of claims 1 to 4, wherein the method comprises using an UICC device as secure device.

9. The method according to one of claims 1 to 4, wherein the method comprises using handsets as first and second device.
